(19) United States
(12) Patent Application Publication
(10) Pub. No.: US 2023/0090734 A1
(43) Pub. Date: Mar. 23, 2023

(54) DIRECTED ENERGY DEPOSITION NOZZLE ASSEMBLY WITH NOZZLE AND VIBRATOR THAT VIBRATES NOZZLE, AND DIRECTED ENERGY DEPOSITION APPARATUS HAVING SUCH NOZZLE ASSEMBLY

(71) Applicant: BEAM, Strasbourg (FR)

(72) Inventors: ALEXANDER STEINBERG, Woodland Park, CO (US); REX ALEXANDRE, Laguna Vista, TX (US)

(21) Appl. No.: 17/787,038

(22) PCT Filed: Dec. 21, 2020
(86) PCT No.: PCT/IB2020/001133

§ 371 Date: Jun. 17, 2022

Related U.S. Application Data
(60) Provisional application No. 62/951,235, filed on Dec. 20, 2019.

(51) Int. Cl. B22F 12/53; B05B 15/50; B05B 7/22; B22F 10/25; B23K 26/144; B23K 26/14; B23K 26/34; B23K 26/70; B05B 7/14

(52) U.S. Cl. CPC B22F 12/53; B05B 15/50; B05B 7/228; B22F 10/25; B23K 26/144; B23K 26/1476; B23K 26/34; B23K 26/702; B05B 7/1445; B33Y 30/00

(57) ABSTRACT

A directed energy deposition nozzle assembly including (1) a nozzle configured to dispense material for directed energy deposition, wherein the material comprises one or more of metallic powder, ceramic powder, and glass powder, and wherein (a) the nozzle has an orifice through which the material exits the nozzle, wherein the nozzle comprises an inner body and an outer body that is peripherally disposed around the inner body, and wherein the orifice is defined by a gap between the inner body and the outer body, or (b) the nozzle comprises a plurality of orifices through which the material exits the nozzle, and (2) a vibrator configured to apply a vibration to the nozzle.

### FIELD OF THE INVENTION

The present invention relates to a nozzle assembly for use in a directed energy deposition apparatus. More particular, the present invention relates to a nozzle assembly which is for use in a directed energy deposition apparatus and which includes (a) a nozzle and (b) a vibrator that vibrates the nozzle. The present invention also relates to a directed energy deposition apparatus including the nozzle assembly, and to a method of vibrating a directed energy deposition nozzle.

### BACKGROUND OF THE INVENTION

Several 3D-printing or additive manufacturing documents disclose the use of vibration. For example:

(1) Chinese Patent Publication No. 106363903 A, according to an English-language Abstract, discloses, e.g., a three-dimensional printing device with an injector head capable of being vibrated, wherein an ultrasonic vibration device is installed in the injector head.

(2) International Patent Application Publication No. WO 2017/151837 A1 (corresponding to European Patent Application Publication No. 3423227 A1) discloses, e.g., additive manufacturing with metallic composites, wherein a nozzle may include one or more ultrasound transducers. The document states that ultrasound energy may facilitate extrusion by mitigating clogging by reducing adhesion of a build material to an interior surface of the nozzle.

(3) U.S. Patent Application Publication No. 2018/0126665 A1 discloses, e.g., an additive manufacturing system having a vibration nozzle.

(4) S. J. Wolff, et al., “In-situ high-speed X-ray imaging of piezo-driven directed energy deposition additive manufacturing,” Scientific Reports (2019), 9:962, discloses, e.g., a vibration-assisted powder delivery system including a piezo element.

However, in the field of directed energy deposition, there remains a need for an improved nozzle assembly and for the prevention of formation of accumulation of melted powder at the tip of the nozzle, which need is met by the present invention.

### SUMMARY OF THE INVENTION

In one aspect, the present invention relates to a directed energy deposition nozzle assembly comprising: (1) a nozzle configured to dispense material for directed energy deposition, wherein the material comprises one or more of metallic powder, ceramic powder, and glass powder, and wherein (a) the nozzle has an orifice through which the material exits the nozzle, wherein the nozzle comprises an inner body and an outer body that is peripherally disposed around the inner body, and wherein the orifice is defined by a gap between the inner body and the outer body, or (b) the nozzle comprises a plurality of orifices through which the material exits the nozzle, and (2) a vibrator configured to apply a vibration to the nozzle. Preferably, the nozzle further has an opening through which an energy beam exits the nozzle.

Preferably one or more of the following conditions are satisfied: (1) the orifice defined by the gap is disposed peripherally around the opening through which the energy beam exits the nozzle, (2) the material exits the orifice defined by the gap in a stream comprising the material and a gas, (3) the orifice defined by the gap and the opening through which the energy beam exits the nozzle are configured such that the material is melted by the energy beam, (4) the energy beam comprises a laser beam, (5) the gas comprises a shielding gas, (5) the orifice defined by the gap is an annular orifice, (6) the annular orifice is coaxially disposed around the opening through which the energy beam exits the nozzle, (7) the shielding gas comprises an inert gas, (8) the vibrator comprises (a) an electric motor and (b) a movable weight that is moved by the electric motor to impart the vibration to the nozzle, (9) the vibrator is peripherally disposed around an outer circumference of the nozzle, (10) the vibrator is removably attached to an external surface of the nozzle, (11) the vibrator comprises a ring-shaped silicone body that contacts the external surface of the nozzle, (12) the electric motor moves the weight back and forth along a direction perpendicular to a longitudinal axis of the nozzle, (13) the nozzle has a frustoconical exterior shape with a truncated end facing a location where the energy beam melts the material, (14) the annular orifice is disposed on the truncated end, (15) the inner body of the nozzle has a frustoconical shape, (16) the outer body of the nozzle has a frustoconical shape and is hollow, (17) the annular orifice is formed by an interior edge of the outer body and an exterior edge of the inner body, (18) the vibration is applied so as to effect at least one of the following: (a) dislodging of powder adhering to the nozzle, (b) preventing powder from adhering to the nozzle, (c) reducing non-uniformity of a distribution of powder from the nozzle, and (d) acting against formation of an agglomeration of melted powder on the nozzle, (19) the plurality of orifices are disposed at different circumferential positions with respect to a longitudinal axis of the nozzle, (20) the plurality of orifices number two to six orifices, arranged at equally spaced circumferential positions with respect to the longitudinal axis of the nozzle, (21) the plurality of orifices provide a respective plurality of streams each comprising the material and a gas, the respective plurality of streams converging at a location where the material is melted by the energy beam, and (22) the material comprises metallic powder.

In another aspect, the present invention relates to an apparatus comprising: (1) a supply of a material comprising one or more of metallic powder, ceramic powder, and glass powder, (2) a source of an energy beam, and (3) a directed energy deposition nozzle assembly as discussed above, wherein the nozzle of the nozzle assembly emits the material, and wherein the energy beam melts the material to form an object. Preferably, one or more of the following conditions are satisfied: (1) the energy beam comprises a laser beam, (2) the material comprises metallic powder, (3) the nozzle has the orifice defined by the gap, (4) the orifice is configured to emit a stream comprising the material and a gas, wherein the stream assumes a conical form upon exiting the orifice, (5) the nozzle further has an opening through which the laser beam is emitted, (6) the orifice circumferentially surrounds the opening, (7) the stream does not include any resin or binder, (8) the vibration is not ultrasonic, (9) the gas comprises a shielding gas, (10) the apparatus further comprises a controller configured to control at least one of (a) an on/off state of the vibrator, (b) a frequency of the vibration, and (c) a magnitude of the vibration, (11) the orifice is annular and the opening is round, (12) the stream consists of metallic powder and the shielding gas, and (13) the shielding gas comprises an inert gas.

In yet another aspect, the present invention relates to a method comprising: applying a vibration to a nozzle of a direct energy deposition apparatus, the nozzle emitting (1) a mixture comprising (a) one or more of metallic powder, ceramic powder, and glass powder, and (b) a gas and (2) a laser beam that melts the one or more of metallic powder, ceramic powder, and glass powder, so as to reduce a melted accumulation of the one or more of metallic powder, ceramic powder, and glass powder on the nozzle, wherein the nozzle has an orifice configured to emit the mixture in a stream that circumferentially surrounds the laser beam where the mixture exits the orifice.

These and other objects, aspects, advantages and features of the present invention will become more apparent from the following detailed description of the presently preferred embodiments taken in conjunction with the accompanying drawings.

### BRIEF DESCRIPTION OF THE DRAWINGS

FIG. 1 is a schematic block diagram showing a first embodiment of the present invention.

FIG. 2 is a cross-sectional view showing the structure of a lower part of a nozzle of the first embodiment.

FIG. 3 is a detail view of FIG. 2, when vibration is not being used.

FIG. 4 is an orthogonal view along the z-axis from below the nozzle of the first embodiment.

FIG. 5 is an orthogonal view along the z-axis from below the nozzle of a second embodiment of the present invention.

FIG. 6 is a cross-sectional view showing the structure of a lower part of the nozzle of the second embodiment.

FIG. 7 is an orthogonal view showing a nozzle assembly according to the present invention.

FIG. 8 is a schematic cross-sectional view of FIG. 7.

FIG. 9 is a schematic cross-sectional detail view of FIG. 8.

### DETAILED DESCRIPTION OF THE PREFERRED EMBODIMENTS

### First Embodiment

(1) General Description

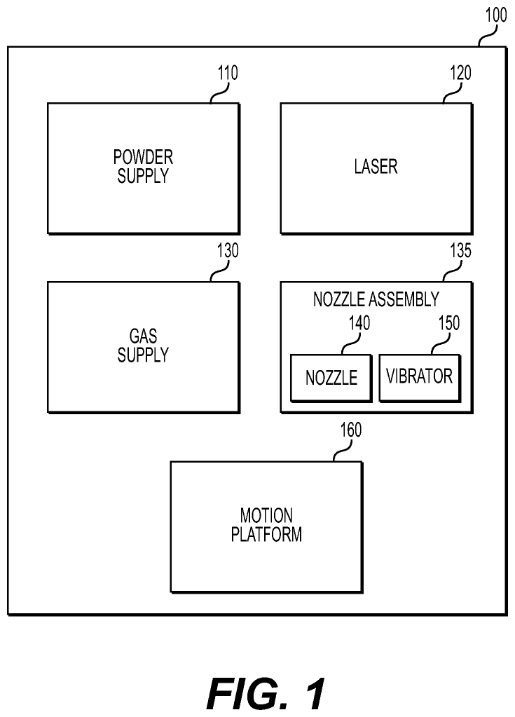

FIG. 1 is a schematic block diagram showing a first embodiment of the present invention, including a directed energy deposition (DED) apparatus 100.

Apparatus 100 includes (1) powder supply 110, (2) laser 120, (3) gas supply 130, (4) nozzle assembly 135, which includes nozzle 140 and vibrator 150, and (5) motion platform 160.

Most preferably, the apparatus 100—excluding the vibrator 150—may be embodied by, for example, a Magic 800 directed energy deposition additive manufacturing machine, with the nozzle 140 being a 10 Vx or 24 Vx coaxial deposition head, all available from BeAM Machines, headquartered in Strasbourg, France, a subsidiary of AddUp Group.

(2) Powder Supply

Powder supply 110 supplies powder which is to be emitted from nozzle assembly 135, and in particular from nozzle 140. The powder is an example of a material for directed energy deposition, i.e., a material to be melted by laser 120 so as to construct an object that has been designed. Preferably, the powder comprises metallic powder. Preferably, the metallic powder comprises one or more of (a) titanium powder, (b) aluminum powder, (c) stainless steel powder, (d) INCONEL® alloy (from Special Metals Corporation) powder, or (e) tungsten carbide powder. The powder may alternatively or additionally comprise ceramic powder. For example, the powder may comprise both metallic powder and ceramic powder together. The powder may alternatively or additionally comprise glass powder. Preferably, the DED material does not include any binder or resin. Most preferably, the DED material consists of metallic powder.

(3) Laser

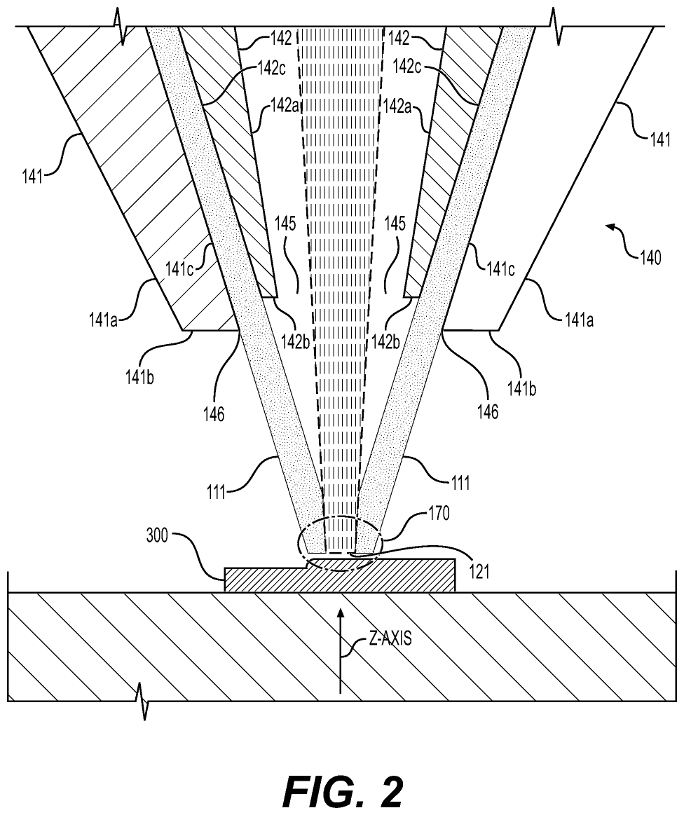

Laser 120 emits a laser beam for melting the material to perform DED. Preferably laser 120 is a fiber or diode laser. Preferably, the power of laser 120 is up to 6 kilowatts, more preferably 300 watts to 2 kilowatts. Preferably, the laser wavelength of laser 120 is 1070 nm. Preferably, for laser 120, the laser spot size at a focal point is within the range of 0.8 mm to 1.5 mm, with the two endpoints representing two typical laser spots sizes. The laser beam emitted by laser 120 is identified in FIG. 2 by reference numeral 121. While the present embodiment has been described as using a laser, the present invention is not limited to use of a laser; instead, any energy source may be used including, for example, an electron beam source that provides an electron beam.

(4) Gas Supply

Gas supply 130 provides gas which is to be emitted from nozzle assembly 135, and in particular from nozzle 140. Preferably, the gas and the powder are emitted together in a stream, e.g., as a mixture, referred to as a “powder stream” or “blown powder.” Such a stream is identified in FIG. 2 by reference numeral 111.

Preferably, the gas comprises shielding gas. More preferably, the gas comprises inert gas. Examples include argon and/or helium. Still more preferably, the gas comprises argon. The gas may consist of inert gas. Further, the gas may comprise oxygen. For example, the gas may comprise oxygen plus an inert gas, e.g., oxygen plus argon. An example of the foregoing is the shielding gas argon-oxygen.

(5) Nozzle Assembly

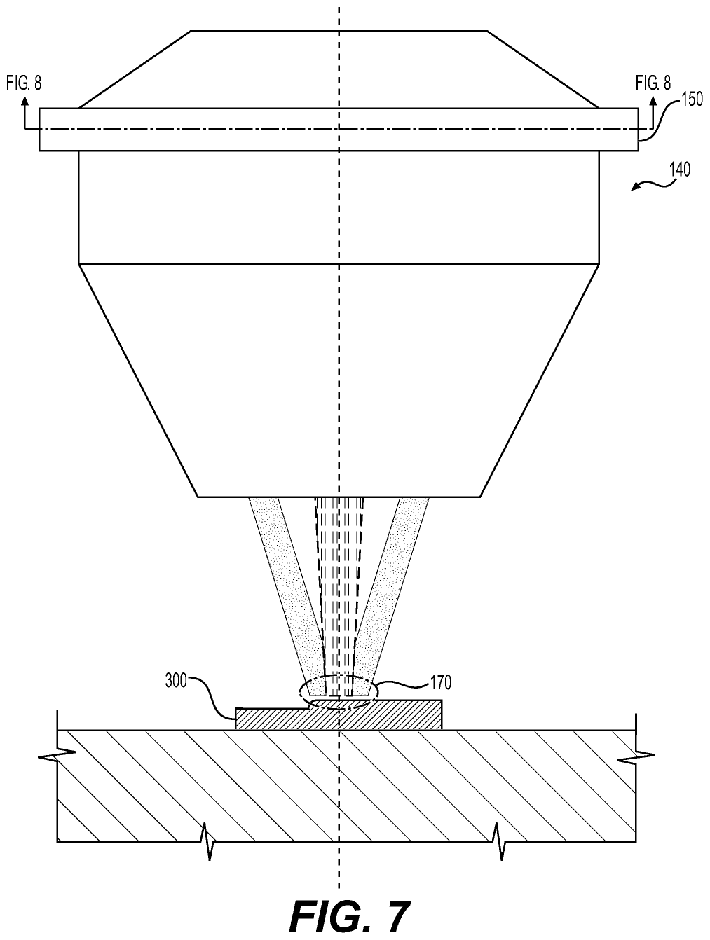

Nozzle assembly 135 comprises nozzle 140 and vibrator 150, as schematically illustrated in FIG. 1, and as shown in orthogonal view in FIG. 7, which shows vibrator 150 circumferentially mounted around an exterior surface of nozzle 140.

(6) Nozzle

As shown in FIG. 2, nozzle 140 has an orifice 146 from which exits powder stream 111, and an opening 145 from which exits laser beam 121. Preferably powder stream 111, having exited orifice 146, and laser beam 121, having exited opening 145, converge at melt pool 170 where laser beam 121 melts the powder in powder stream 111 to form an object 300 that has been designed. In other words, orifice 146 and opening 145 are configured such that the powder is melted by laser beam 121 to form the object 300.

More preferably, nozzle 140 is configured such that powder stream 111 converges within a region which is about five times a spot size formed by laser beam 121. Thus, if the spot size is 0.8 mm, then preferably powder stream 111 converges within 4 mm of the beam focal point. If, on the other hand, the spot size is 1.5 mm, then preferably powder stream 111 converges within 7.5 mm of the beam focal point.

Preferably, nozzle 140 comprises a plurality of structural components, preferably made of metal, including outer body (also referred to as outer cone) 141 and inner body (also referred to as an inner cone) 142. Outer body 141 is peripherally radially disposed about inner body 142. As shown in FIG. 2, outer body 141 includes (a) exterior surface 141a which is an exterior surface of nozzle 140, preferably angling radially outward away from a longitudinal axis (e.g., z-axis) of nozzle 140, (b) bottom surface 141b, which faces melt pool 170, preferably a flat surface, and (c) interior surface 141c, which faces radially inward. Outer body 141 preferably has a frustoconical exterior shape with a truncated end facing melt pool 170, which gives the bottom part of nozzle 140 that same shape. Outer body 141 is hollow, with inner body 142 disposed in its cavity.

Inner body 142 includes (a) interior surface 142a, which faces radially inward, (b) bottom surface 142b, which faces melt pool 170 and which preferably is flat, and (c) exterior surface 142c, which faces radially outward and thus which faces interior surface 141c of outer body 141. Inner body 142 also preferably has a frustoconical shape. Inner body 142 has an inner cavity defined by interior surface 142a, which culminates at the bottom of inner body 142 in opening 145 through which laser beam 121 exits. Preferably opening 145 is circular.

There is a gap between interior surface 141c of outer body 141 and exterior surface 142c of inner body 142. This gap extends downward through nozzle 140, preferably at an angle with respect to the longitudinal axis of nozzle 140, and defines a passage within nozzle 140 through which powder stream 111 moves. The gap culminates at the bottom of nozzle 140 in orifice 146 through which powder stream 111 exits the nozzle. In other words, orifice 146 is defined by the gap between outer body 141 and inner body 142, and in particular orifice 146 is formed by an interior edge of outer body 142 and an exterior edge of inner body 141.

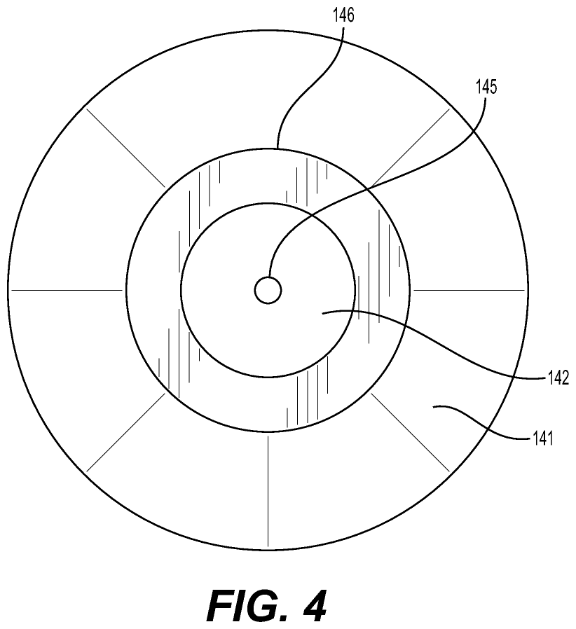

Preferably, orifice 146 is peripherally disposed around opening 145. FIG. 4 shows an example of such disposition. In this figure, when viewed along the longitudinal axis (e.g., z-axis) of nozzle 140 from melt pool 170 towards the bottom surface of nozzle 140, orifice 146 is peripherally radially disposed around opening 145. It can be said that orifice 146 circumferentially surrounds opening 145.

Preferably, orifice 146 is an annular orifice. Also, preferably, orifice 146 is coaxially disposed around opening 145.

Preferably, nozzle 140 (including its inner body 141, outer body 142, orifice 145, and orifice 146) is configured such that at least one of the following conditions is satisfied: (a) powder stream 111 circumferentially surrounds laser beam 121 where powder stream 111 exits orifice 146 and (b) powder stream 111 assumes a conical form upon exiting orifice 146.

As mentioned above, most preferably, nozzle 140 is a BeAM model 10 Vx or 24 Vx coaxial deposition head.

(7) Vibrator

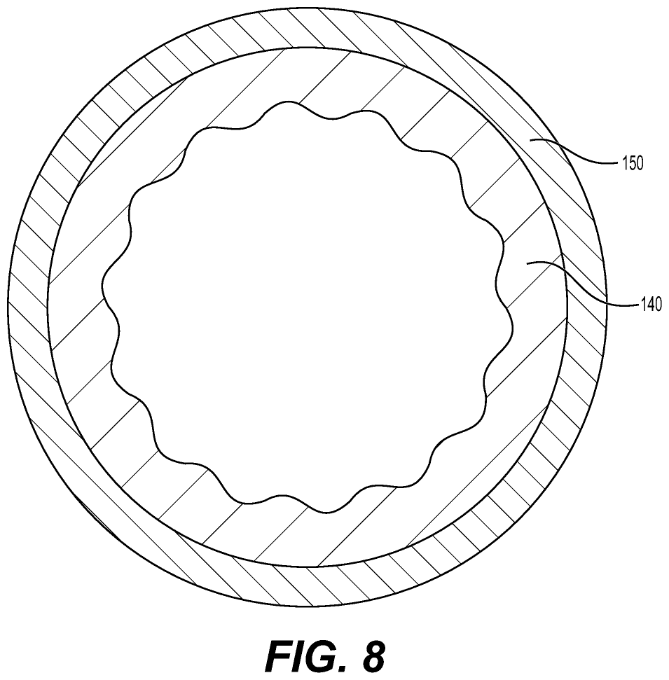

As mentioned above, vibrator 150 is preferably circumferentially mounted around an exterior surface (e.g., outer circumference) of nozzle 140, as shown in FIG. 7. Such mounting is also shown in FIG. 8, which is a schematic cross-sectional view of FIG. 7. (In FIG. 8, the wavy line indicates an area where the internal structure of nozzle 140 is not depicted). Preferably, vibrator 150 is removably mounted.

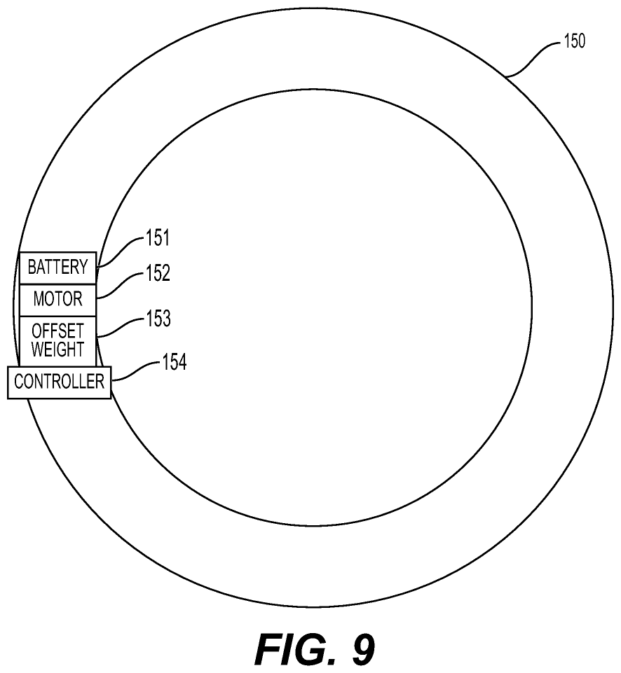

As schematically shown in FIG. 9, vibrator 150 preferably comprises (1) battery 151, (2) electric motor 152, (3) offset weight 153, and (4) controller 154. Offset weight 153 is movably mounted, and is driven by electric motor 152 to move, so as to impart a vibration to nozzle 140. The ring shape in FIG. 9 schematically represents that vibrator 150 preferably comprises a ring-shaped silicone body that contacts the external surface of nozzle 140. Preferably, electric motor 152 moves offset weight 153 back and forth along a direction perpendicular to a longitudinal axis of nozzle 140 (e.g., a radial direction). Controller 154 may include a switch and/or circuitry that control at least one of (a) an on/off state of vibrator 150, (b) a frequency of the vibration, and (c) a magnitude of the vibration.

In this embodiment, the frequency of the vibration is other than ultrasonic.

In this embodiment, vibrator 150 is a commercially-available massage tool intended for human usage which we have repurposed for use in the embodiment.

Also, in this embodiment, vibrator 150 has only one offset weight 153, which therefore is disposed at one circumferential location with respect to nozzle 140; however, the present invention is not limited to one offset weight 153 or circumferential location. Nor is the present invention limited to use of the specific vibrator mentioned above, or to use of the specific frequency of vibration mentioned above.

(8) Motion Platform 160

Motion platform 160 provides relative motion between nozzle assembly 135 and a surface upon which the designed object is being formed by DED. Preferably, nozzle assembly 135 remains still and the surface is moved.

(9) Vibrating Operation of Nozzle Assembly

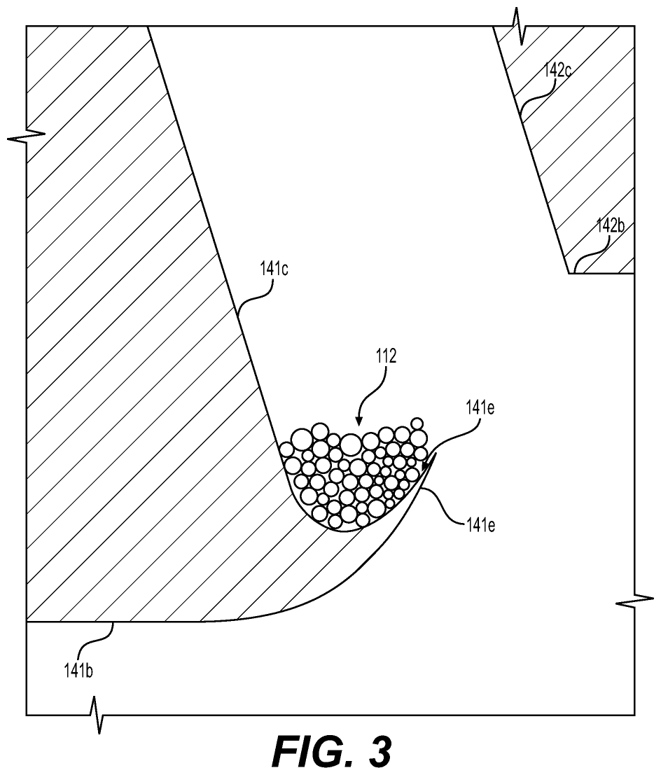

FIG. 3 represents a detail cross-sectional view of a lower part of nozzle 140, before vibrator 150 is turned on, and reflects the inventors' present understanding of how nozzle 140 may operate when vibrator 150 is not imparting vibration to nozzle 140. In particular, interior surface 141c and bottom surface 141b are designed to form a sharp corner at a specific angle without a lip; however, it is possible that, because of the method of construction of nozzle 140, deformed cone edge 141d, which is not intended to be present, is formed instead, thereby providing an upwardly extending lip that defines a cup-shaped area 141e. That area is thought to accumulate powder 112. In other words, powder from powder stream 111, instead of exiting orifice 146 may be caught by cup-shaped area 141e, preventing its exit from orifice 146. In such a case, the heat of laser beam 121 may melt some of powder 112, resulting in an agglomeration of melted powder on nozzle 140 (sometimes referred to as a boulette). If the agglomeration is sufficiently large, it can be necessary to stop using nozzle 140 so that nozzle 140 can be cleaned. Furthermore, the agglomeration may disrupt the exit powder stream 111 from orifice 146, resulting in an increase in non-uniformity of distribution of powder from nozzle 140.

The inventors have found that by operating vibrator 150, in some cases it has been possible to increase the time of operation for nozzle 140 (before it is necessary to stop operating nozzle 140 to clean an agglomeration from the same) from, e.g., (a) 8-30 minutes to (b) several hours. Furthermore, the inventors have found that by operating vibrator 150, nozzle 140 appears to be distributing a powder stream with reduced non-uniformity. In particular, when vibrator 150 is not operated, the inventors noticed that in some instances a formed object might have diminished surface quality, particularly in one quadrant usually, but that when vibrator 150 is operated, such diminished surface quality is reduced. It appears that operating vibrator 150 results in reduced non-uniformity of powder distribution, and thus in improved workpiece quality.

In other words, operating vibrator 150 appears to bring about at least one of the following: (a) dislodging of powder adhering to the nozzle, (b) preventing powder from adhering to the nozzle, (c) reducing non-uniformity of a distribution of powder from the nozzle, and (d) acting against formation of an agglomeration of melted powder on the nozzle.

### Second Embodiment

A second embodiment of the present invention will now be described, in which description the use of the same reference numerals represent the same structures as in the first embodiment. The second embodiment differs from the first embodiment only in that a different nozzle is used. In particular, while the first embodiment of the present invention has, as one feature, emission of powder stream 111 through an orifice defined by a gap between an inner body and a peripherally disposed outer body, the present invention is not limited to such an orifice; in the second embodiment, the nozzle instead has a plurality of orifices through which the powder exits.

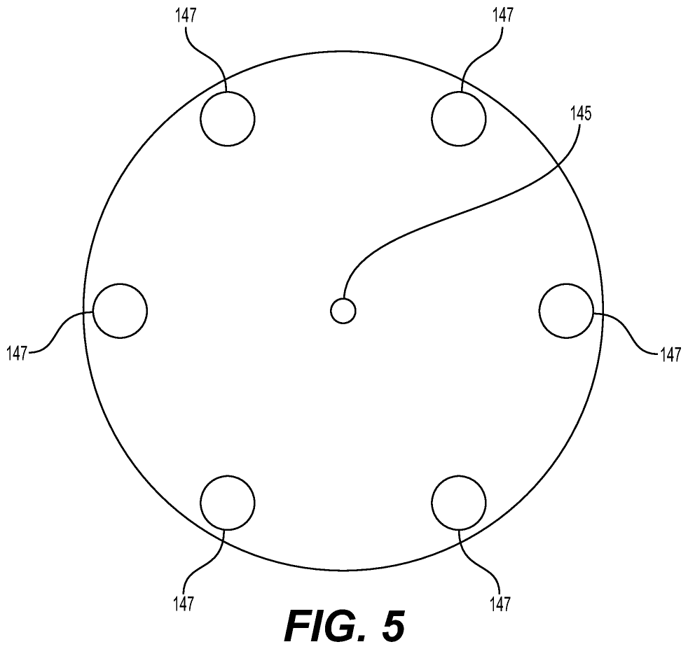

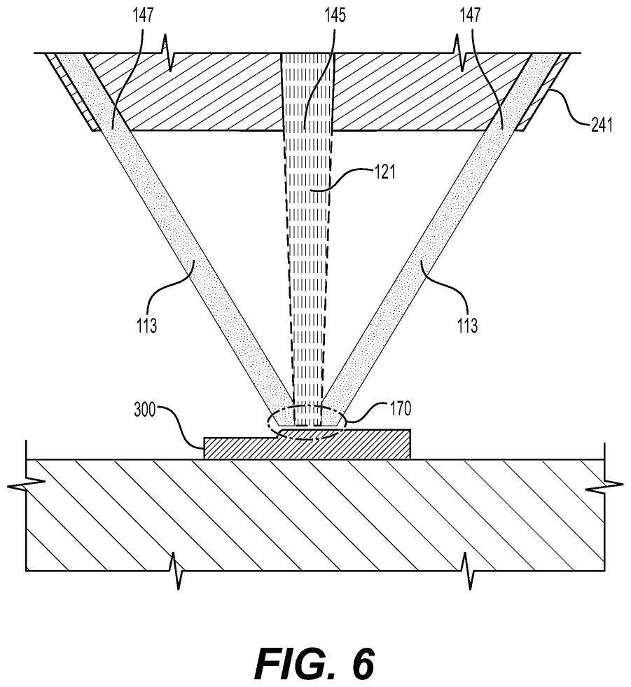

FIG. 5 is an orthogonal view along the longitudinal (e.g., z-axis) from below the nozzle of the second embodiment. Here, the nozzle, which is identified by reference numeral 241, has a flat bottom face which faces melt pool 170. That face has (a) an opening 145 through which laser beam 121 exits, and (b) a plurality of orifices 147 through which a respective plurality of powder streams 113 exit. Orifices 147 are disposed at different circumferential positions with respect to a longitudinal axis of nozzle 241. Orifices 147 preferably number two to six in total (FIG. 5 shows six such orifices), and preferably they are arranged at equiangular circumferential positions with respect to the longitudinal axis of nozzle 241. FIG. 6 depicts, in cross-section, powder streams 113 exiting orifices 147 and converging at a location where laser beam 121 melts the powder in powder streams 113 (i.e., a melt pool) to form a designed object.

The second embodiment is otherwise like the first embodiment, in using vibrator 150 around an exterior surface of nozzle 241, as shown in FIG. 6.

Of course, in all embodiments, the present invention is not limited to having vibrator 150 so positioned, and instead vibrator 150 could be located somewhere else in, on, or around the nozzle.

### INDUSTRIAL APPLICABILITY

The present invention provides an improved DED nozzle assembly, and an improved DED apparatus having such a nozzle assembly. Benefits of the present invention include improved nozzle run-time and improved uniformity of powder distribution.

### CONCLUSION

Except as otherwise disclosed herein, the various components shown in outline or in block form in the figures are individually well known and their internal construction and operation are not critical either to the making or using of this invention or to a description of the best mode of the invention.

Although specific embodiments of the present invention have been described above in detail, it will be understood that this description is merely for purposes of illustration. When it is said that something “is”, “shall”, “will”, or “should be” the case, for example, these expressions are not meant to limit the invention, but are merely providing a specific example or specific examples. Various modifications of and equivalent structures corresponding to the disclosed aspects of the preferred embodiments in addition to those described above may be made by those skilled in the art without departing from the spirit of the present invention which is defined in the following claims, the scope of which is to be accorded the broadest interpretation so as to encompass such modifications and equivalent structures.

What is claimed is:

1. A nozzle assembly for a directed energy deposition apparatus, the nozzle assembly comprising:
(1) a nozzle configured to dispense material for directed energy deposition,
wherein the material comprises one or more of metallic powder, ceramic powder, and glass powder, and
wherein (a) the nozzle has an orifice through which the material exits the nozzle, wherein the nozzle comprises an inner body and an outer body that is peripherally disposed around the inner body, and wherein the orifice is defined by a gap between the inner body and the outer body, or (b) the nozzle comprises a plurality of orifices through which the material exits the nozzle, and
(2) a vibrator configured to apply a vibration to the nozzle.

2. A nozzle assembly according to claim 1, wherein the nozzle further has an opening through which an energy beam exits the nozzle.

3. A nozzle assembly according to claim 2, wherein the nozzle has the orifice defined by the gap,
wherein the orifice defined by the gap is disposed peripherally around the opening through which the energy beam exits the nozzle,
wherein the material exits the orifice defined by the gap in a stream comprising the material and a gas, and
wherein the orifice defined by the gap and the opening through which the energy beam exits the nozzle are configured such that the material is melted by the energy beam.

4. A nozzle assembly according to claim 3, wherein the energy beam comprises a laser beam, and
wherein the gas comprises a shielding gas.

5. A nozzle assembly according to claim 4, wherein the orifice defined by the gap is an annular orifice,
wherein the annular orifice is coaxially disposed around the opening through which the energy beam exits the nozzle, and
wherein the shielding gas comprises an inert gas.

6. A nozzle assembly according to claim 3, wherein the vibrator comprises (1) an electric motor and (2) a movable weight that is moved by the electric motor to impart the vibration to the nozzle.

7. A nozzle assembly according to claim 6, wherein the vibrator is peripherally disposed around an outer circumference of the nozzle.

8. A nozzle assembly according to claim 7, wherein the vibrator is removably attached to an external surface of the nozzle.

9. A nozzle assembly according to claim 8, wherein the vibrator comprises a ring-shaped silicone body that contacts the external surface of the nozzle, and
wherein the electric motor moves the weight back and forth along a direction perpendicular to a longitudinal axis of the nozzle.

10. A nozzle assembly according to claim 6, wherein the nozzle has a frustoconical exterior shape with a truncated end facing a location where the energy beam melts the material, and
wherein the annular orifice is disposed on the truncated end.

11. A nozzle assembly according to claim 6, wherein the inner body of the nozzle has a frustoconical shape,
wherein the outer body of the nozzle has a frustoconical shape and is hollow, and
wherein the annular orifice is formed by an interior edge of the outer body and an exterior edge of the inner body.

12. A nozzle assembly according to claim 6, wherein the vibration is applied so as to effect at least one of the following: (a) dislodging of powder adhering to the nozzle, (b) preventing powder from adhering to the nozzle, (c) reducing non-uniformity of a distribution of powder from the nozzle, and (d) acting against formation of an agglomeration of melted powder on the nozzle.

13. A nozzle assembly according to claim 1, wherein the nozzle has the plurality of orifices through which the material exits the nozzle.

14. A nozzle assembly according to claim 13, wherein the plurality of orifices are disposed at different circumferential positions with respect to a longitudinal axis of the nozzle.

15. A nozzle assembly according to claim 14, wherein the plurality of orifices number two to six orifices, arranged at equally-spaced circumferential positions with respect to the longitudinal axis of the nozzle,
wherein the plurality of orifices provide a respective plurality of streams each comprising the material and a gas, the respective plurality of streams converging at a location where the material is melted by the energy beam, and
wherein the energy beam comprises a laser beam.

16. An apparatus comprising:
a supply of a material comprising one or more of metallic powder, ceramic powder, and glass powder;
a source of an energy beam; and
a directed energy deposition nozzle assembly according to claim 1,
wherein the nozzle of the nozzle assembly emits the material, and
wherein the energy beam melts the material to form an object.

17. An apparatus according to claim 16, wherein the energy beam comprises a laser beam,
wherein the nozzle has the orifice defined by the gap,
wherein the orifice is configured to emit a stream comprising the material and a gas, wherein the stream assumes a conical form upon exiting the orifice,

18. An apparatus according to claim 17, wherein the nozzle further has an opening through which the laser beam is emitted,
wherein the orifice circumferentially surrounds the opening,
wherein the stream does not include any resin or binder, and
wherein the gas comprises a shielding gas.

19. An apparatus according to claim 18, further comprising a controller configured to control at least one of (a) an on/off state of the vibrator, (b) a frequency of the vibration, and (c) a magnitude of the vibration,
wherein the orifice is annular and the opening is round, and
wherein the stream consists of metallic powder and the shielding gas, and
wherein the shielding gas comprises an inert gas.

20. A method comprising:
applying a vibration to a nozzle of a direct energy deposition apparatus, the nozzle emitting (1) a mixture comprising (a) one or more of metallic powder, ceramic powder, and glass powder, and (b) a gas and (2) a laser beam that melts the one or more of metallic powder, ceramic powder, and glass powder so as to reduce a melted accumulation of the one or more of metallic powder, ceramic powder, and glass powder on the nozzle,
wherein the nozzle has an orifice configured to emit the mixture in a stream that circumferentially surrounds the laser beam where the mixture exits the orifice.
